(19) United States
(12) Patent Application Publication
(10) Pub. No.: US 2006/0288169 A1
(43) Pub. Date: Dec. 21, 2006

(54) Lighter apparatus with data storage capabilities and a data transfer interface

(76) Inventor: Bertram Steiner, (US)

Correspondence Address: Edward Etkin, Esq.;Law Office of Edward Etkin, Esq., PC, Suite A, 228 West End Avenue, Brooklyn, NY, 11235, US

(21) Appl. No.: 11/510,453

(22) Filed: Aug. 24, 2006

(30) Foreign Application Priority Data
Mar. 11, 2004 (AT) AT0400428A5

(51) Int. Cl. G06F 12/00

(52) U.S. Cl. 711/115

(57) ABSTRACT

The inventive apparatus is combination of lighter and data memory device (such as a USB read/write flash drive (e.g., USB memory stick). The novel device comprises, with lighter part (B), consisting of a case (A) with a fuel tank (1) with a fuel pipe line (1,1) and an ignition mechanism (2) on top, and a portable data memory device in a lighter case (A), an integrated read/write control unit (3), an optional attached read/write switch (5), and a data transfer interface (4) to connect the data memory to the, PC optionally protected by a cap (D) or a cover (E).

### CROSS REFERENCE TO RELATED APPLICATION

The present patent application is a continuation-in part of, and claims priority from, the commonly assigned International PCT Patent Application No. WO05088196A1, entitled “USB LIGHTER, COMBINATION OF LIGHTER AND USB READ/WRITE MEMORY (USB STICK)” with an international filing date of Feb. 23, 2005, which in turn claims priority from Austrian Patent Application No. AT0400428A5, entitled “KOMBINATION AUS FEUERZEUG UND USB LESE-/SCHREIBSPEICHER” filed on Mar. 11, 2004

### FIELD OF THE INVENTION

The present invention relates generally to every kind of a combination of a lighter of different styles and a computer memory component (such as a USB read/write flash drive or USB memory stick), which has a memory interface (such as a USB interface) allowing the device to be attached to a computer.

### DESCRIPTION OF THE RELATED ART

Normally, memory devices (such as USB memory sticks) and lighters are completely separate device, such that if a user wants the functionality of a lighter and of portable memory, they need to carry two separate devices with them.

### BRIEF DESCRIPTION OF THE DRAWINGS

In the drawings, wherein like reference characters denote corresponding or similar elements throughout the various figures:

FIG. 1 shows a normal lighter combined with a USB memory stick in accordance with an embodiment of the invention;

FIG. 2 shows a normal lighter combined with a USB memory stick in accordance with another embodiment of the invention;

FIG. 3(I) and (II) show a USB memory stick—lighter combination in accordance with another embodiment of the invention where the lighter (B) and the USB memory stick (C) can be separated by a screw-on top (F);

FIG. 3(III) shows the lighter (B) with the USB memory stick (C) combination in accordance with another embodiment of the invention where the lighter (B) has a notch (8) to protect the USB interface (4);

FIG. 4 shows a model where the case (G) of the USB memory stick (C) has enough room to insert a normal, disposable lighter (B) in accordance with another embodiment of the invention; and FIG. 5 shows a preferably-used mechanical ignition piece for the lighter.

### SUMMARY OF THE INVENTION

In addition to the usefulness of combining a lighter and a memory device, the present invention can also be used for very advantageous advertising opportunities. The combination of a lighter and a memory device in a single apparatus, allows advertisement not only on the outer casing, but also on the “inside”—being able to pass on information through data processing. With a control unit of the novel device, it is possible to pass on all sorts of information or data (such as digital presentations, web links or automated multimedia jingles, etc.), which show up immediately when the memory portion of the device (such as a Universal Serial Bus (USB) interface) is hooked up to a personal computer (PC) or equivalent. This way, the inventive device may be utilized as an advertisement tool, as a lighter with a memory device which may be used as a ROM-advertisement only, or with extra memory capacity for other use as well. The resulting advantage: the advertising effect of the combined unit: a normal lighter with its form of distribution as a present, or handed on personally, combined with an integrated attractive, easy-to-use, portable memory stick, is multiplied.

According to the invention, the above object may be achieved by a combination of lighter and a read/write computer memory device (such as a read/write memory flash drive—e.g., a USB memory stick), with a lighter part (B), consisting of a case (A) with a fuel tank (1) with a fuel pipe line (1,1) and an ignition mechanism (2) on top, and a portable USB stick, in a lighter case (A) integrated memory read/write control unit (3), an attached read/write switch (5) and a memory interface (4) (such as a USB interface) to hook up to a personal computer or equivalent, protected by a cap (D) or a cover (E). Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

It should also be noted that while the inventive MDIE device is shown in various figures and described below, by way of various examples, with reference to USB functionality or “USB memory stick,” as a matter of design choice, the memory portion of the inventive device (and related components, such as the PC interface, control unit, and read/write switch—hereinafter “operational components”), may be readily implemented using any computer data memory type or configuration; with appropriately provided and configured operational components, as a matter of design choice, convenience, or necessity without departing from the spirit of the invention. Thus, the memory component may be standard RAM memory chips, any type of flash memory, a hard drive, etc., with appropriately selected operational components (for example a firewire interface, etc.),

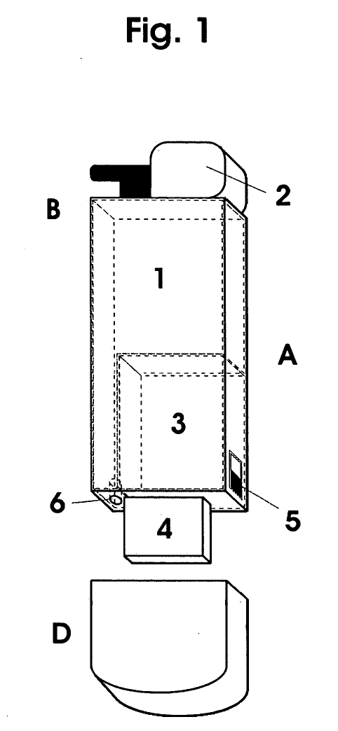

Referring now to the drawings, FIGS. 1-5 show different variations of the novel computer memory device/lighter combination. As noted above, in the preferred embodiment of the invention, the memory device used in accordance herewith is a USB memory stick or equivalent.

Referring now to FIG. 1: In accordance with the present invention, a lighter is combined with a USB memory stick (or other type of memory device having an interface capable of connection to a PC or equivalent) in an outside case (A) composed of one or more desired materials (plastic, metal, etc.). The lighter part consists of a fuel tank (1) with a any type of desired ignition mechanism (2) (depicted in detail in FIG. 5). On the outside case (A) which is either next to, or under, the fuel tank (1) is the memory device part (3-5) comprising a read/write control unit (3) with a USB interface (4) (or any other type of PC data transfer interface), which can be connected to a PC. On the outside of the case (A) is a read/write switch (5), which allows the user to switch the control unit to the desired read/write function. A cap (D) protects the USB interface (4) from mechanical damages. There is a refill vent (6) for the fuel tank (1) next to the USB interface (4) on the bottom of the case.

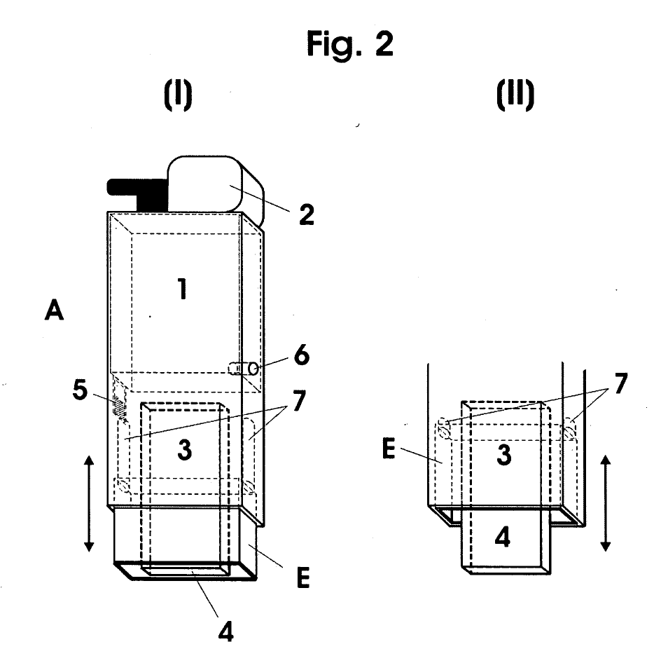

FIG. 2 (I) shows a second embodiment of the present invention: Here the lighter and USB memory stick are again mounted in one case (A). To protect the USB interface (4) a pull-back cover (E) is held in place by springs (7) such as coil spring mounted on the inside of the case (A). FIG. 2 (II) shows the connection to the computer, due to the pressure, the springs (7) give way and the cover (E) slides back into the case (A), thus the USB interface (4) is open. The refill vent (6) of the fuel tank (1) is on the side of the lighter (B).

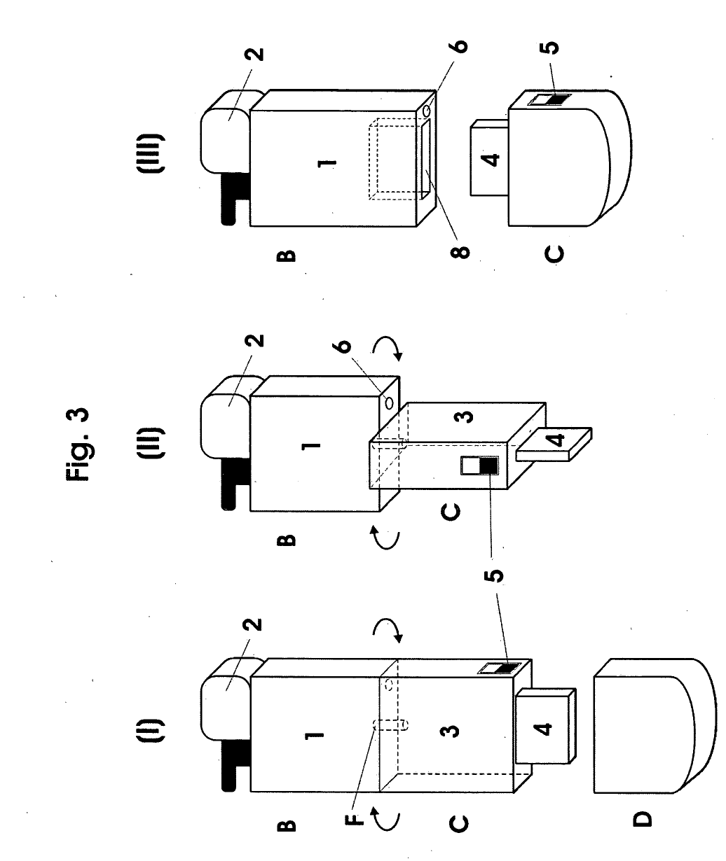

FIG. 3 (I) shows a third embodiment of the present invention, where the lighter (B) and the USB memory stick (C) can be separated by a screw-on top (F), to refill the fuel tank (1). In this embodiment, the fuel tank (1) and the read/write control unit (3) are in separate cases. FIG. 3 (II) shows the lighter (B) separated from the USB memory stick (C), when the fuel tank (1) is being refilled or the USB memory stick (C) is hooked up to the PC. To protect the USB interface (4), it is preferred to also have a cap (D) (as illustrated), and/or also a cover, as depicted in FIG. 2. FIG. 3 (III) shows this embodiment of the inventive device as a lighter (B) with the USB memory stick (C) combination, where the lighter (B) has a notch (8) to protect the USB interface (4).

According to further embodiments of the invention, the screw-on top (F) can be replaced by a plug-in, “bayonet” attachment, or any other variation of attachment.

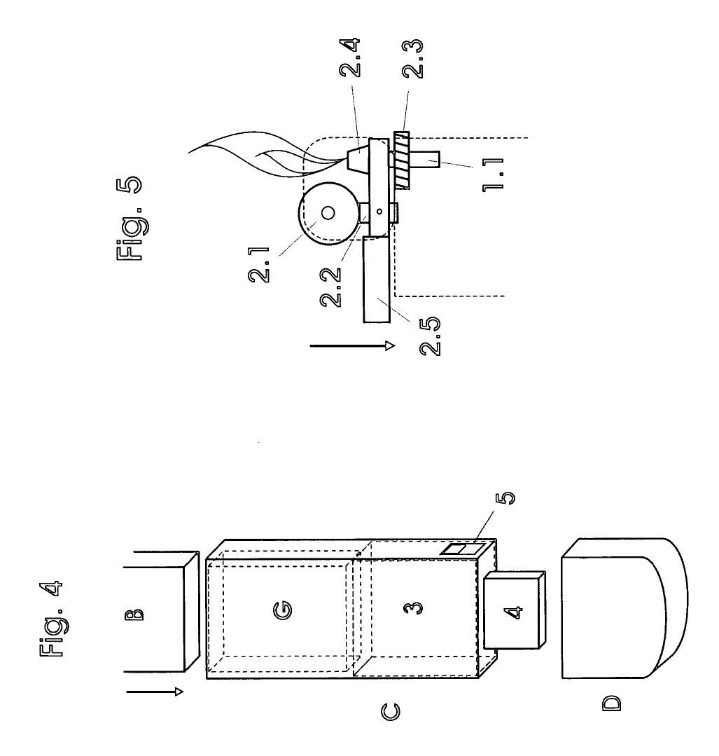

FIG. 4 shows a fourth embodiment of the present invention, where the case (G) of the USB memory stick (C) has enough room to insert a normal, disposable lighter (B) in an interference fit.

FIG. 5 shows a fifth embodiment of the present invention, where a preferably-used mechanical ignition piece, consisting of a ignition-drum (2.1), a flint stone (2.2), a nozzle-control-vent (2.3), a nozzle (2.4), and a lever (2.5). On the inside of the fuel tank (1) is the fuel pipeline (1.1) for the fuel supply to the nozzle (2.4), through the nozzle-control-vent (2.3).

The inventive lighter is equipped, as described above, with a mechanical ignition mechanism, but there are many different possibilities, such as electrical or piezoelectrical, etc. For example, the lighter can be a flameless lighter with a metal net.

As noted above there are now, and there will be in the future, many different forms of small-sized memory devices with PC interfaces (implemented as USB memory sticks and otherwise) varying in functionality, type of control unit, data processing, memory capacity etc, so the inventive device contemplates the above-described embodiments of a lighter with integrated memory functionality and data transfer interface whether available now or that may become available in the future. The above described and depicted embodiments are only a sample of the many different possibilities and changes. Alterations are always possible and it is up to the specialist to make adjustments and improvements without departing from the principle of the present invention. Such modifications still belong to this invention, so that the following claims apply to these alterations as well.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A portable multi-function lighter apparatus comprising:
a substantially hollow elongated case housing, having a first end and a second end;
a lighter component, at least partially disposed in said case housing proximal to said first end, selectively operable to generate heat sufficient to ignite a combustible material, comprising:
a fuel tank operable to store flammable fuel therein, disposed within said case housing,
a user-operable ignition device, operable to ignite fuel delivered thereto, and positioned at said first end, and
a fuel line connected between said fuel tank and said ignition device; and
a data memory component, at least partially disposed in said case housing, proximal to said second end, comprising:
at least one memory device operable to read and write data;
a control unit, operable to control operation of said at least one memory device, and connected thereto, and
a data transfer interface, operable to connect to a computer operable to at least one of: selectively read and write data stored in said memory device.

2. The portable multi-function lighter apparatus of claim 1, further comprising:
means for removing said lighter component from said case housing.

3. The portable multi-function lighter apparatus of claim 2, wherein said lighter component comprises a disposable lighter.

3. The portable multi-function lighter apparatus of claim 1, wherein said ignition device is one of: electronic, piezo-electronic, a flint-stone, and flint and drum.

4. The portable multi-function lighter apparatus of claim 1, wherein said lighter component is flameless

5. The portable multi-function lighter apparatus of claim 1, wherein at least one of said lighter component, and said memory component comprises a corresponding housing, further comprising releasable attachment means for releasably coupling at least two of: said lighter component, said memory component, and said case housing.

6. The portable multi-function lighter apparatus of claim 5, wherein said releasable attachment means comprises one of: screw and thread, plug and receptacle, a bayonet-style connector.

7. The portable multi-function lighter apparatus of claim 1, further comprising protective means for protecting said data transfer interface from harm.

8. The portable multi-function lighter apparatus of claim 7, wherein said protective means comprises one of: a removable cap sized and configured to enclose said data transfer interface, and a cover operable to restrict access to said data transfer interface.

9. The portable multi-function lighter apparatus of claim 1, further comprising a selective user-operable control element positioned on at least one of said data memory component and said case housing operable to control data reading and writing operation of the data memory component.

10. The portable multi-function lighter apparatus of claim 1, wherein said fuel tank comprises a user-accessible refill vent for adding fuel thereto.

11. The portable multi-function lighter apparatus of claim 1, further comprising:
at least one visible advertising element disposed on said case housing exterior, and
advertising data stored in said data memory unit corresponding to said at least one visible advertising element.
